(19) United States
(12) Patent Application Publication
(10) Pub. No.: US 2004/0096072 A1
(43) Pub. Date: May 20, 2004

(54) Microphone equipped with a range finder

(76) Inventor: Birger Orten, Alesund (NO)

Correspondence Address: LADAS & PARRY, 224 SOUTH MICHIGAN AVENUE, SUITE 1200, CHICAGO, IL, 60604, US

(21) Appl. No.: 10/468,324

(22) PCT Filed: Feb. 20, 2002
(86) PCT No.: PCT/NO02/00071

(30) Foreign Application Priority Data
Feb. 21, 2001 (WO) PCT/NO01/00064
Dec. 6, 2001 (NO) 2001 5985

(51) Int. Cl. H04R 1/02; H04R 3/00

(52) U.S. Cl. 381/113; 381/91; 381/122

(57) ABSTRACT

A microphone is equipped with an element (13) for measuring the distance to a sound emitter, for example the face of an artist. The distance measurement element (13) can be part of the acousto-electric transducer (7) of the microphone, and it can be a piezo-electric ultrasound echo range finder (15, 16).

The present invention relates to a microphone that comprises a microphone housing, an acoustoelectric transducer in a forward part of the housing for receiving sound from a sound emitter, as well as equipment for transferring sound-representing signals from the transducer, out from the microphone to external sound signal processing equipment.

Microphones, and in particular song microphones, often have a problem in the fact that the distance from the microphone to the sound emitter, for instance the mouth of an artist, influences the sound resulting from the microphone recording. Microphones have various types of directional characteristics and various types of distance response, and often a manufacturer will undertake optimalization with regard to certain parameters, when making a microphone. Hence, one special microphone will for example be intended to be used at a very close range, while some other microphone may be manufactured to pick up sound from a larger distance. A microphone that has been optimised for one certain type of use, may provide a poor result when the use deviates somewhat from the originally intended use, and the result may be exaggerated S sounds, incorrect frequency response etc.

U.S. Pat. No. 4,586,195 discloses a microphone range finder system in which reproduced speech is improved by compensating for the position of a speaker relative to a microphone system that includes a microphone and separate range finder or range finders. This system is intended for measuring distances across tables or across small or large rooms, and the microphone and range finder or range finders are separate units. The system is suitable for improving conditions for instance when a speaker walks away from a stationary microphone, however not in a situation where a speaker or singer holds the microphone in his/her hands.

Thus, there still remains a need of a microphone of a more flexible type, i.e. a microphone that can easily be adjusted regarding optimalization parameters for varying distances to a nearby sound emitter. The present invention aims at solving this problem, and in accordance with the invention there is provided a microphone such as stated in the introduction, and which is characterized in that it is equipped with an element for measuring the distance to the sound emitter.

In an important embodiment of the invention, the element for measuring distance is included in the acoustoelectric transducer. The transducer may then be constituted by elastic piezoelectric toils suspended in a surrounding frame and having a massive centre body, the centre body containing the element for measuring distance.

The element for measuring distance may be and ultrasound echo range finder. The ultrasound echo range finder may comprise two piezoelectric elements, one for emitting a narrow ultrasound beam forwards toward the sound emitter, and one for receiving ultrasound echo from the sound emitter.

Alternatively, the element for measuring distance may be a laser range finder.

An inside compartment in the microphone housing may contain circuitry for generating, respectively interpreting signals to, respectively from the element for measuring distance. Parts of the circuitry may be adapted for generating ultrasound oscillations for exciting a piezoelectric ultrasound transmitter element, and other parts of the circuitry may be operative for receiving and interpreting received signals from a piezoelectric ultrasound receiver element.

Alternatively, parts of the circuitry may be adapted for generating control signals for emitting light from a laser element in the element for measuring distance, and other parts of the circuitry may be operative for receiving and interpreting received reflection signals from a light detector in the distance measuring element.

In one embodiment of the microphone of the invention, the microphone includes a circuit device for utilizing the measured distance, said circuit device having at least one function among a function group that comprises

shutting down transfer of sound-representing signals from the microphone,

adjusting a gain factor as a function of measured distance, and

adjusting an equalizer setting as a function of measured distance.

In one further embodiment of the microphone in accordance with the invention, the element for measuring distance and circuitry attached thereto, are also adapted for sound detection through demodulation of a reflection signal from the sound emitter, said reflection signal, being a high frequency signal, receiving superposed sound modulation from the sound emitter and from ambient noise.

In the following, the invention shall be discussed in closer detail, going through exemplary embodiments, and in this connection it is referred to the appended drawings, in which

FIG. 1 shows a microphone in accordance with the invention, in an embodiment with a cable,

FIG. 2 shows a microphone in accordance with the invention, with a wireless transmission system,

FIG. 3 shows the same microphone as FIG. 1, however without a microphone housing enclosure,

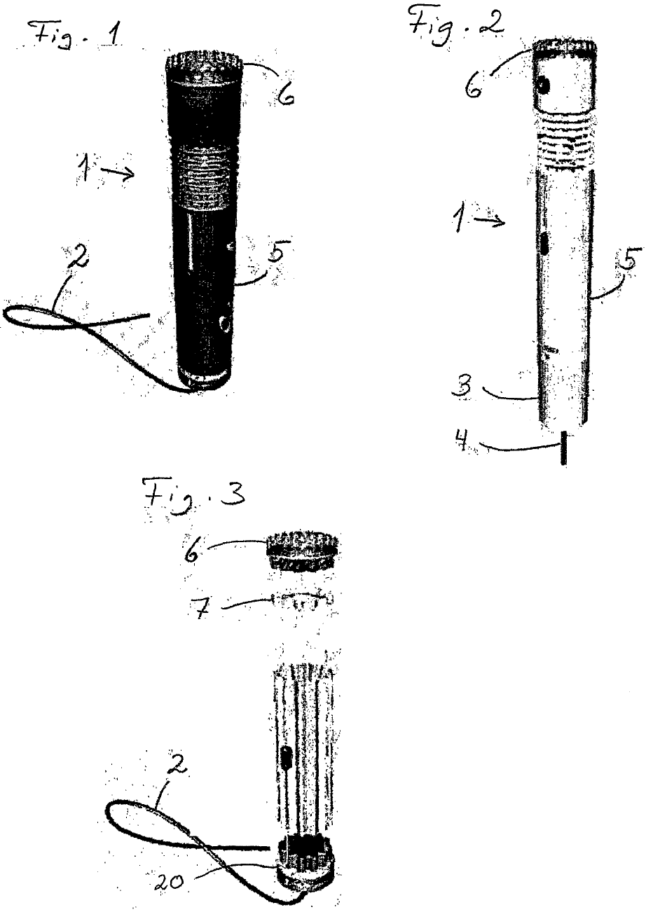

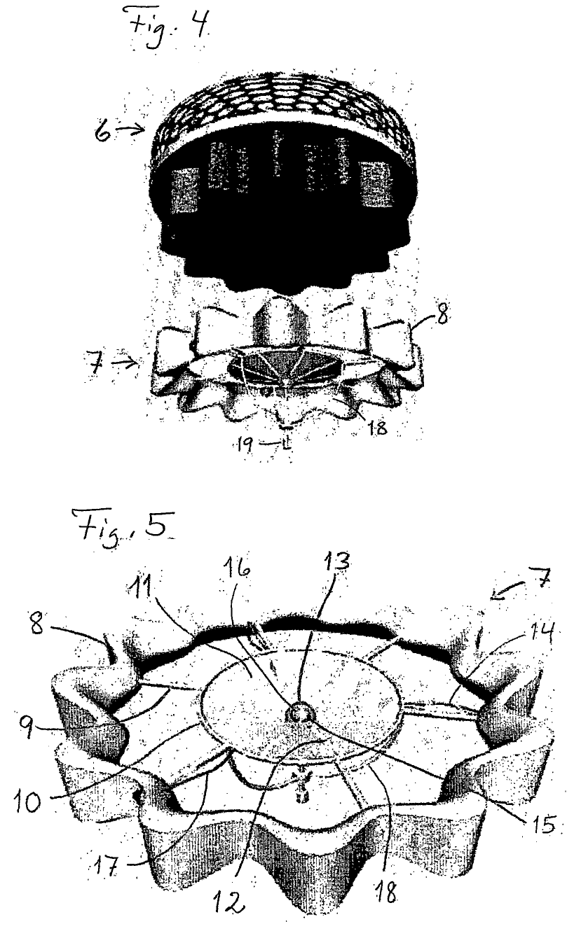

FIG. 4 shows the top parts appearing from FIG. 3 in closer detail, and

FIG. 5 shows the sound transducer of the microphone.

First it must be pointed out that the embodiments mentioned herebelow, are only meant to be examples of how to realize the microphone in accordance with the invention, while limitations should only appear from the appended independent claim. Hence, the microphone of the invention is not specified in detail with regard to how to process, in the microphone, sound that has been picked up, nor with regard to how the sound is processed by equipment for processing signals transferred from the microphone, nor with regard to how electric sound-representing signals are transferred from the microphone, for instance via an attached cable or via a wireless transmission system. Hence, in FIGS. 1 and 2 appear two embodiments of the microphone 1 in accordance with the invention, with transmission through a signal cable 2 (FIG. 1), respectively via a radio transmitter 3 and antenna 4 (FIG. 2). For the rest, only outer details appear in FIGS. 1 and 2, while the details that are essential for the present invention, appear from the following FIGS. 3, 4 and 5.

In FIG. 3 appears a microphone that corresponds to the one shown in FIG. 1, however without an outer microphone housing 5 (FIG. 1, FIG. 2). The same microphone top 6 as in FIG. 1 and FIG. 2 appears also in FIG. 3 and FIG. 4, but these figures show an acoustoelectric transducer 7, shown in better detail in FIG. 5. The primary function of the transducer 7 is of course picking up sound vibrations transferred through the air from a sound emitter, for example from the mouth of an artist, and further transferred through the grill-shaped microphone top 6. The transducer 7 as shown has an outer frame 8, and supported rigidly therein via beams 9, an inner frame 10. Inside frame 10 there is a number of piezoelectric membrane foils having sector shape and small radial slits 12 between sectors. Centrally, the foil pieces 11 are attached to a centre body 13. When sound waves hit the sector-shaped foil membranes, they get into an oscillatory state, and the movements result in generation of voltages in the piezoelectric foils. These voltages are output by means of wires 14, each respective foil piece 11 being equipped with separate signal wires. Such a transducer, intended to be used in a preferred embodiment of the microphone of the invention, is discussed in applicant's previous U.S. patent application having Ser. No. 09/788,607, filed 21 Feb. 2001. In this U.S. patent application appear the following variants, for which priority is claimed in the present invention:

In the very centre body 13, piezo-elements 15, 16 have been laid in, i.e. one piezo-element 15 for transmitting vibrations, and one piezo-element 16 for receiving reflected vibrations. Signal wires to/from the piezo-elements of the centre body do not appear in FIG. 5, however they follow paths on sectors 11 from the centre body 16 and out to signal wires 17 appearing in the figure. The piezo-elements 15 and 16 are in this case cast-in “half moons” of a piezo-material. The manner of operation will be e.g. that the centre body piezo-element 15 transmits high-frequency vibrations, preferably in the range 5-10 MHz (however not limited to such a range), in order to make an echo sounder measurement, possibly an echo Doppler investigation for more precise examination of the movement mode of the sound emitter.

Reflected vibrations are picked up by means of element 16. The ultrasound beam that is transmitted from the centre body, can be very narrow and directional, and may for example pass centrally out through the microphone top 6, i.e. through a special centre hole. The two “crescent shaped” piezo-elements 15 and 16 can also have a parabolic or approximately parabolic curvature, to achieve transmission of a narrow beam, and for correspondingly directional reception.

The different sectors of the sound receiving element with piezo-foils 11 can also be used both for transmission and reception, however this is of less interest in a microphone embodiment. The separate sectors provide mainly possibilities for electronic signal combinations, in order to cancel out noise.

Another feature of the transducer element is the tautening system on the underside of the centre frame 10. A system of stays 18 provides support for a tightening screw 19 that, when operated, is able to pull the centre body 13 some distance in a downwards direction, so as to impart a downward slanting position toward the centre body 13, for the foil sectors 11 inside centre frame 10, thereby giving the whole active part of the transducer a somewhat more “parabolic” shape, and hence more directional. If the centre screw 19 constitutes a stiff coupling all the way up to the centre body 13 on the underside, only with a possibility for accommodating rotation, the centre body 13 is locked with regard to vibration in a vertical direction, and the foil sectors 11 will then only be able to vibrate between such a fixed centre body 13 and a fixed inner frame 10. But if a link between the tightening screw 19 and the centre body 13 is equipped with an elastic part, the whole system of foil sectors and the centre body will still have a vibrational mode in the vertical direction, however modified by the influence of the elastic link.

Signals to/from the active elements 11, 15, 16 in the transducer are forwarded along signal wires 14, 17 (FIG. 5), as mentioned, and further to/from the base unit 20 shown in FIG. 3. This base unit 20 may contain signal processing equipment, for example an A/D converter, a controllable/programmable equalizer, amplifier and other equipment. On the other hand, it is also possible to convey the signals to/from the active elements directly via wire 2 if the microphone is of a type with cable attachment. However, with regard to the range finder system with which the microphone is equipped, it is of particular interest with internal circuitry, contained in base part 20, for generating ultrasound signals for the piezo-element 15, as well as circuitry for reception and interpretation of received reflection signals from piezo-element 16. The base part 20 will preferably contain a power source in the form of a battery, which power source will also be necessary for operating possible other circuitry as mentioned above, and in the case with wireless transfer to external equipment (FIG. 2), also for operating a radio transmitter/receiver in unit 3 (FIG. 2). Furthermore, the circuitry for interpretation of range finding signals will be operative for utilization of the measurement result, for example by shutting down transfer of sound-representing signals from the microphone if the distance to the sound emitter exceeds a certain predefined threshold value. Correspondingly, it will be possible to utilize the range finding result for adjustment of a gain factor of the built-in amplifier, possibly for an amplifier in the external equipment, and then in such a manner that a short distance may entail attenuation, while a longer measured distance will entail increased gain. In addition it is possible to influence a frequency curve, i.e. an equalizer setting, as a function of measured distance, for instance with a basis in known relations between distance to sound emitter and presence of certain undesired frequency crests or frequency dips in the sound result.

As regards cancelling noise, the centre body with its range finding system also has a double function. It Is a fact that the high frequency ultrasound signal that is transmitted from element 15 to be reflected from the sound emitter, after reflection also will receive a slower vibration as a superposition, namely the sound of interest from the sound emitter, and possibly also some noise from the surroundings. These slow sound vibrations (that is, stow relative to the high frequency used in the actual range finding measurement) can be separated from the high frequency oscillations, by means of signal processing, and they can be used as a basis for signal processing for the sound vibrations that are also picked up through the foil sectors 11, and in particular with regard to cancelling noise and undesired sounds from the sound signals. The circuitry in base element 20 can also be adapted for such a function.

So far, only an ultrasound element arranged centrally in the very sound transducer, has been mentioned as a range finder element. It is also possible to arrange a similar ultrasound range finder in some other position on the microphone, but with the same function and with the same type of connection to signal-processing circuitry.

Another type of range finder that is per se known, is a device utilizing a laser beam, and it is possible to incorporate a small laser diode, possibly with micro-optics, in the same position as the unit shown in FIG. 5, namely in the actual centre body 13. A laser beam, preferably using infrared light, is then emitted through a corresponding opening in the microphone top 6, to be reflected from the sound emitter and back to a light detector arranged together with the laser. Such a laser range finder can also be arranged in some other place on the microphone, for instance peripherally. (Such a range finder can be retrofit equipment.) However, for obvious reasons a central position will be preferable.

Finally it must be mentioned that the present invention is one of several inventions regarding a complete microphone, all of these inventions being made subject of patent applications simultaneously, and it is referred to Norwegian patent application no. 2001 5983 regarding “A song microphone with signal processing equipment”, Norwegian patent application no. 2001 5982 regarding “A microphone with variable ventilation”, and Norwegian patent application no. 2001 5984 regarding “A microphone with exchangeable details”. To the degree that these simultaneously filed patent applications exhibit features suitable for explaining or completing features of the present invention, these applications are hereby incorporated in the present specification by reference.

1. A microphone, comprising a microphone housing (5), an acousto-electric transducer (7) in a forward part of the housing (5) for receiving sound from a sound emitter, as well as equipment for transferring sound-representing signals from the transducer (7), out of the microphone (1) and to external sound signal processing equipment,
characterized in that the microphone (1) is equipped with an element (15, 16) for measuring the distance to said sound emitter.

2. The microphone of claim 1,
characterized in that said element (15, 16) for measuring distance is included in the acousto-electric transducer (7).

3. The microphone of claim 2,
characterized in that said transducer (7) is constituted by elastic piezo-electric foils (11) suspended in a surrounding frame (18) and with a massive centre body (13), said centre body (13) containing said element (15, 16) for measuring distance.

4. The microphone of claim 1, 2 or 3,
characterized in that said element (15, 16) for measuring distance is an ultrasound echo range finder.

5. The microphone of claim 4,
characterized in that said ultrasound echo range finder (15, 16) comprises two piezo-electric elements, one (15) for transmitting a narrow ultrasound beam in a direction forwards toward the sound emitter, and one (16) for receiving ultrasound echo from said sound emitter.

6. The microphone of claim 1,
characterized in that said element for measuring distance is a laser range finder.

7. The microphone of claim 1,
characterized in that an inner compartment of said housing (5) contains circuitry for generating, respectively interpreting signals to, respectively from said element (15. 16) for measuring distance.

8. The microphone of claim 7,
characterized in that parts of said circuitry are operative for generating ultrasound oscillations for exciting a piezo-electric ultrasound transmitter element (15), and other parts of said circuitry are operative for receiving and interpreting received signals from a piezo-electric ultrasound receiver element (16).

9. The microphone of claim 7,
characterized in that parts of said circuitry are operative for generating control signals for emitting light from a laser element in said range finder, and other parts of said circuitry are operative for receiving and interpreting received reflection signals from a light detector in said range finder.

10. The microphone of claim 1,
characterized in that it includes a circuit device for utilizing measured distance, said circuit device having at least one function among a function group comprising
shutting down transfer of sound-representing signals from the micro-phone (1),
adjustment of a gain factor as a function of measured distance, and
adjustment of an equalizer setting as a function of measured distance.

11. The microphone of claim 1,
characterized in that said element (15, 16) for measuring distance and circuitry attached thereto are also operative for sound detection by demodulation of a reflection signal from said sound emitter, said reflection signal, being a high frequency signal, receiving sound modulation from said sound emitter and from ambient noise, as a superposition.
